(19) United States
(12) Patent Application Publication
(10) Pub. No.: US 2025/0202092 A1
(43) Pub. Date: Jun. 19, 2025

(54) MICROWAVE CHANNEL BETWEEN ADJACENT MICROWAVE CAVITIES INCLUDING QUBITS

(71) Applicant: INTERNATIONAL BUSINESS MACHINES CORPORATION, ARMONK, NY (US)

(72) Inventor: Muir Kumph, Croton on Hudson, NY (US)

(21) Appl. No.: 18/542,558

(22) Filed: Dec. 15, 2023

(51) Int. Cl. H01P 7/06; G06N 10/40; H01P 7/08

(52) U.S. Cl. CPC H01P 7/06; G06N 10/40; H01P 7/086

(57) ABSTRACT

A structure includes a first chip substantially located in a first microwave cavity, a second chip substantially located in a second microwave cavity, and a microwave channel connecting the first microwave cavity and the second microwave cavity. The first microwave cavity has a first mode, the second microwave cavity has a second mode, and the microwave channel has a third mode. The third mode dissipates the first mode and the second mode in the microwave channel. The structure further includes a coupling from the first chip to the second chip through the microwave channel.

### BACKGROUND

The present disclosure generally relates to structures for signal transmission and more particularly to signal transmission between adjacent chips in microwave cavities.

A microwave cavity is a type of resonator including a substantially closed metal structure that confines microwaves. The metal structure may be either hollow or filled with dielectric material. The microwaves bounce back and forth between walls of the microwave cavity. At the cavity's resonant frequencies, the microwaves reinforce to form standing waves in the cavity.

A computing system may include chips in adjacent microwaves cavities. Signals may be transmitted between the chips via striplines in multi-layer wiring (MLW), coplanar waveguides, etc.

### SUMMARY

According to various embodiments, a structure includes a first chip substantially located in a first microwave cavity, a second chip substantially located in a second microwave cavity, and a microwave channel connecting the first microwave cavity and the second microwave cavity. The first microwave cavity has a first mode, the second microwave cavity has a second mode, and the microwave channel has a third mode. The third mode dissipates the first mode and the second mode in the microwave channel. The structure further includes a coupling from the first chip to the second chip through the microwave channel.

In some embodiments, the microwave channel has an aspect ratio of greater than 4:1.

In some embodiments, the coupling includes a first finger extending from the first chip into the microwave channel and terminating in a first end, and a second finger extending from the second chip into the microwave channel and terminating in a second end. The second end forms a gap with the first end.

In some embodiments, the first and second fingers include coplanar waveguides.

In some embodiments, the first and second fingers each have a length-to-width ratio of about 2:1.

In some embodiments, finger length is at least twice as great as finger width.

In some embodiments, the first and second ends are electrically coupled across the gap.

In some embodiments, the first chip includes a first semiconductor substrate, and the second chip includes a second semiconductor substrate. The first finger is integral with the first semiconductor substrate, and the second finger is integral with the second semiconductor substrate.

In some embodiments, the first chip includes a first qubit, the second chip includes a second qubit, and the first and second fingers are configured to transmit quantum signals between the first and second qubits.

In some embodiments, the first qubit is at an edge of the first chip, and the second qubit is at an edge of the second chip.

According to various embodiments, a quantum system includes a quantum processor. The quantum processor includes a conductive body having a plurality of microwave cavities and microwave channels extending between the microwave cavities. The quantum processor further includes a plurality of chips located in the microwave cavities. Each chip includes at least one qubit and an integral finger protruding from a chip edge and extending into an adjacent one of the microwave channels. The integral finger of each chip is configured to transmit a quantum signal.

In some embodiments of the quantum system, at least one qubit of each chip is located at a chip edge.

In some embodiments of the quantum system, each chip includes a substrate, and each finger includes a protrusion integral with the substrate and extending from the substrate.

In some embodiments of the quantum system, the protrusion of each chip is configured as a coplanar waveguide.

In some embodiments of the quantum system, length-to-width ratio of each finger is at least 2:1.

According to various embodiments, a method includes forming circuitry on a semiconductor substrate, machining a millimeter-sized protrusion having an aspect ratio of at least 2:1 at an edge of the semiconductor substrate, and forming electrical conductors on the protrusion to extend from the circuitry to a free end of the protrusion.

In some embodiments of the method, waterjet-guided laser machining or abrasive waterjet machining are used to machine the protrusion at the edge of the substrate.

In some embodiments of the method, forming the circuitry includes forming a qubit at the edge of the semiconductor substrate.

In some embodiments of the method, the protrusion and the electrical conductors are configured as a coplanar waveguide.

These and other features will become apparent from the following detailed description of illustrative embodiments thereof, which is to be read in connection with the accompanying drawings.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all the components or steps that are illustrated. When the same numeral appears in different drawings, it refers to the same or like components or steps.

FIG. 1 is a structure including first and second microwave cavities and a microwave channel extending between the first and second microwave cavities, consistent with an illustrative embodiment.

FIG. 2 is a computing system including the structure of FIG. 1, first and second chips in the first and second microwave cavities, and a coupling in the microwave channel, consistent with an illustrative embodiment.

FIG. 3 is an illustration of a gap between first and second fingers in the microwave channel, consistent with an illustrative embodiment.

FIG. 4 is an illustration of the first finger integral with the first chip, the second finger integral with the second chip, and qubits at edges of the first and second chips, consistent with an illustrative embodiment.

FIG. 5 is a quantum processor, consistent with an illustrative embodiment.

FIG. 6 is a method of fabricating a finger that is integral with a chip, consistent with an illustrative embodiment.

### DETAILED DESCRIPTION

In the following detailed description, numerous specific details are set forth by way of examples to provide an understanding of the relevant teachings. However, it should be apparent that the present teachings may be practiced without such details. In other instances, well-known methods, procedures, components, and/or circuitry have been described at a relatively high-level, without detail, to avoid unnecessarily obscuring aspects of the present teachings.

The present disclosure relates to electrical coupling of adjacent chips in microwave cavities. By virtue of the concepts discussed herein, microwave channels are used to reduce noise in signals transmitted between the chips. The noise reduction has particular value with respect to signals transmitted between adjacent qubits in quantum systems.

According to various embodiments of the present disclosure a structure includes a first chip substantially located in a first microwave cavity, a second chip substantially located in a second microwave cavity, and a microwave channel connecting the first microwave cavity and the second microwave cavity. The first microwave cavity has a first mode, the second microwave cavity has a second mode, and the microwave channel has a third mode. The third mode dissipates the first mode and the second mode in the microwave channel. The structure further includes a coupling from the first chip to the second chip through the microwave channel.

In some embodiments, which can be combined with the preceding embodiment, the microwave channel has an aspect ratio of greater than 4:1. Strength of the magnetic field associated with each mode is reduced exponentially going further into the microwave channel. The higher the aspect ratio, the better the shielding.

In some embodiments, which can be combined with the preceding embodiments, the coupling includes a first finger extending from the first chip into the microwave channel and terminating in a first end, and a second finger extending from the second chip into the microwave channel and terminating in a second end. The second end forms a gap with the first end. The fingers enable the first and second chips to remain in their respective cavities, yet have a close physical connection.

In some embodiments, which can be combined with the preceding embodiments, the first and second fingers include coplanar waveguides (CPWs). The CPWs have very low loss, which makes them advantageous for transmitting quantum signals.

In some embodiments, which can be combined with the preceding embodiments, finger length is at least twice as great as finger width. The higher the aspect ratio, the better the shielding.

In some embodiments, which can be combined with the preceding embodiments, the first and second fingers each have a length-to-width ratio of about 2:1. Although a higher ratio provides better shielding, it also results in a finger that is more fragile. The 2:1 ratio provides a good balance between shielding and fragility.

In some embodiments, which can be combined with the preceding embodiments, the first and second ends are electrically coupled across the gap.

In some embodiments, which can be combined with the preceding embodiments, the first chip includes a first semiconductor substrate, and the second chip includes a second semiconductor substrate. The first finger is integral with the first semiconductor substrate, and the second finger is integral with the second semiconductor substrate. Making the fingers integral with their respective chips avoids the need for connections to the chips and, therefore, avoids losses associated with the connections.

In some embodiments, which can be combined with the preceding embodiments, the first chip includes a first qubit, the second chip includes a second qubit, and the first and second fingers are configured to transmit quantum signals between the first and second qubits.

The structure is especially useful for shielding quantum signals transmitted between qubits. The amount of energy in a quantum signal is equivalent to a single photon. Even the slightest amount of noise can cause that energy to be lost. The structure suppresses noise and protects information in the quantum signal.

In some embodiments, which can be combined with the preceding embodiments, the first and second qubits are at edges of the first and second chips, respectively.

According to various embodiments of the present disclosure a quantum system includes a quantum processor. The quantum processor includes a conductive body having a plurality of microwave cavities and microwave channels extending between the microwave cavities. The quantum processor further includes a plurality of chips located in the microwave cavities. Each chip includes at least one qubit and an integral finger protruding from an edge of the chip and extending into an adjacent one of the microwave channels. The integral finger of each chip is configured to transmit a quantum signal.

In some embodiments of the quantum system, which can be combined with the previous embodiment of the quantum system, at least one qubit of each chip is located at a chip edge.

In some embodiments of the quantum system, which can be combined with the previous embodiments of the quantum system, each chip includes a substrate, and each finger includes a protrusion integral with the substrate and extending from the substrate.

In some embodiments of the quantum system, which can be combined with the previous embodiments of the quantum system, the protrusion of each chip is configured as a coplanar waveguide.

In some embodiments of the quantum system, which can be combined with the previous embodiments of the quantum system, length-to-width ratio of each of the fingers is at least 2:1.

In some embodiments of the quantum system, which can be combined with the previous embodiments of the quantum system, the quantum processor further includes a local classical controller, and a classical quantum interface. The classical quantum interface is configured to receive command signals from the local classical controller and convert those signals into a format for performing quantum operations on the quantum processor.

According to various embodiments of the present disclosure, a method includes forming circuitry on a semiconductor substrate, machining a millimeter-sized protrusion having an aspect ratio of at least 2:1 at an edge of the semiconductor substrate, and forming electrical conductors on the protrusion to extend from the circuitry to a free end of the protrusion.

In some embodiments of the method, which can be combined with the previous embodiment of the method, waterjet-guided laser machining or abrasive waterjet machining are used to machine the protrusion at the edge of the semiconductor substrate.

In some embodiments of the method, which can be combined with the previous embodiments of the method, forming the circuitry includes forming a qubit at the edge of the semiconductor substrate.

In some embodiments of the method, which can be combined with the previous embodiments of the method, the protrusion and the electrical conductors are configured as a coplanar waveguide.

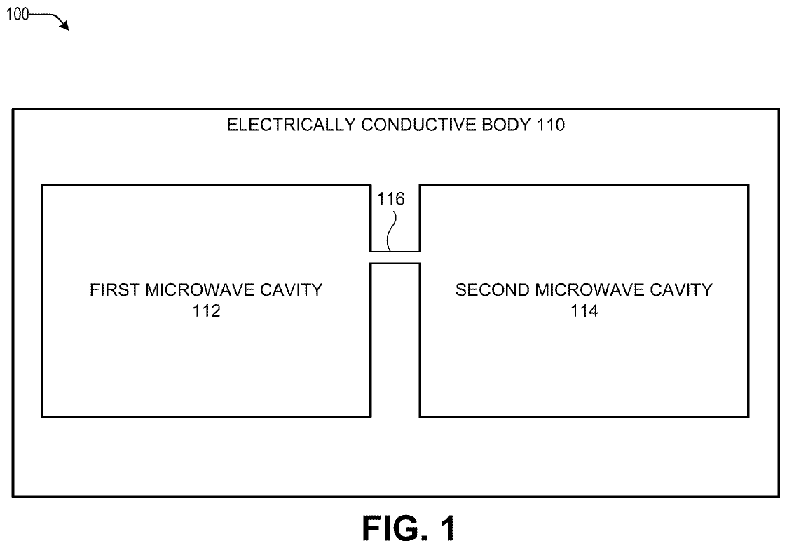

Reference is made to FIG. 1, which illustrates a structure 100 including an electrically conductive body 110 having a spaced-apart first cavity 112 and a second microwave cavity 114. The electrically conductive body 110 may be made of metal, and the first microwave cavity 112 and second microwave cavity 114 may be machined into the conductive body 110. Each microwave cavity 112 and 114 causes microwaves within to be reinforced at the cavity's resonant frequencies, forming standing waves.

The first microwave cavity 112 has a first mode, and the second microwave cavity 114 has a second mode. As used herein, a mode may refer to spatial shape as well as resonant frequency. As a first example, the first and second modes may have the same resonant frequency (number) but are distinct because they have different shapes. As a second example, the first and second modes have the same resonant frequency and the same shape.

The conductive body 110 also has a microwave channel 116 extending between the first microwave cavity 112 and second microwave cavity 114. The microwave channel 116 may also be machined into the conductive body 110. The microwave channel 116 is millimeter-sized and may have an aspect ratio of greater than 4:1. Width of the microwave channel 116 is much less than wavelength of microwave radiation associated with the mode, and may be 1-2 mm for example (wavelength of microwave radiation in the 3 GHz range is about 10 cm).

The microwave channel has a third mode. The third mode dissipates the first mode and the second mode in the microwave channel 116. Strength of the magnetic field associated with each mode is reduced exponentially going further into the microwave channel 116. The higher the aspect ratio of the microwave channel 116, the better the shielding.

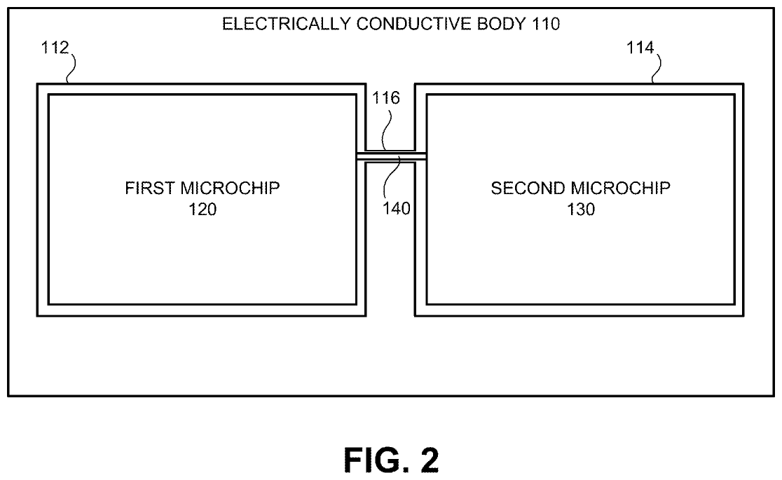

Reference is made to FIG. 2, which illustrates the structure 100 including a first chip 120 substantially located in the first microwave cavity 112, and a second chip 130 substantially located in the second microwave cavity 114. The structure 100 further includes a coupling 140 located within the microwave channel 116. The coupling 140 is configured for signal transmission between the first and second chips 120 and 130.

In some embodiments, the coupling 140 includes first and second “fingers” 142 and 144. As used herein, a finger 142 or 144 refers to a signal transmission medium having an aspect ratio of at least 2:1. That is, finger length is at least twice as great as finger width. The signal transmission medium may be, for example, a coplanar waveguide. The coplanar waveguide has very low loss, which makes it advantageous for transmitting quantum signals. If higher signal loss can be tolerated, striplines in multi-layer wiring may be used instead.

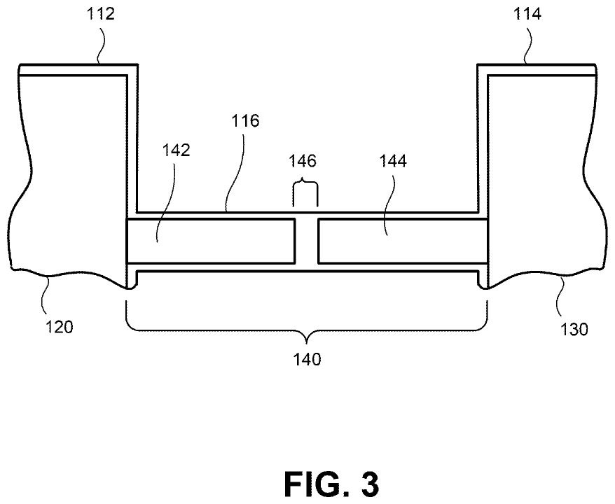

Additional reference is made to FIG. 3. The first finger 142 extends from the first chip 120 into the microwave channel 116 and terminates in a first end. The second finger 144 extends from the second chip 130 into the microwave channel 116 and terminates in a second end. The first and second ends form a gap 146.

The ends of the first finger 142 and second finger 144 are electrically coupled across the gap 146. The coupling may be capacitive coupling or inductive coupling. Alternatively, the gap 146 may be bridged galvanically by wire bonding or a third chip with bump bonds. A signal may be transmitted down one finger 142 or 144, across the gap 146, and to the other finger 144 or 142.

In some embodiments, the fingers 142 and 144 may be integral with the first and second chips 120 and 130, respectively. Making the first finger 142 and second finger 144 integral with their respective chips 120 and 130 avoids the need for connections to the chips 120 and 130 and, therefore, avoids losses associated with the connections.

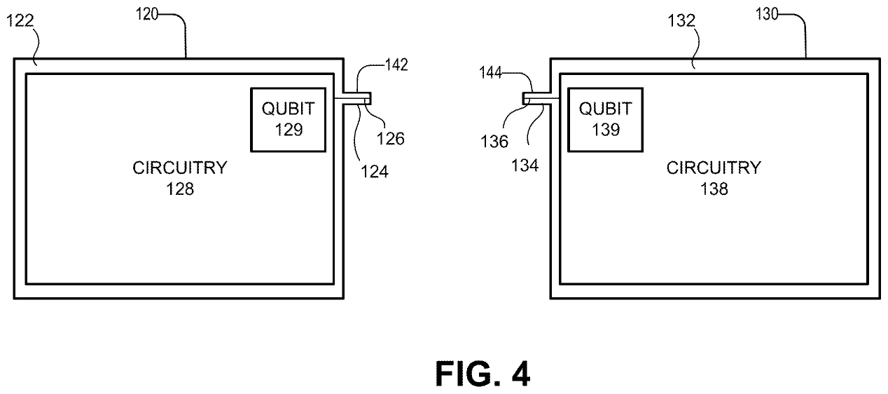

Reference is now made to FIG. 4, which illustrates an embodiment in which the first finger 142 is integral with the first chip 120, and the second finger 144 is integral with the second chip 130. The first chip 120 includes a first semiconductor substrate 122 having a first protrusion 124. Conductors 126 are formed on the first protrusion 124. The first protrusion 124 and the conductors 126 provide the first finger 142. For example, the first finger 142 may be configured as a coplanar waveguide by a dielectric layer on the first protrusion 124, and conductors 126 including a conducting track and a pair of return tracks on the dielectric layer.

Similarly, the second chip 130 includes a second semiconductor substrate 132 having a second protrusion 134. Conductors 136 are formed on the second protrusion 134 to provide the second finger 144.

The first finger 142 may be connected to circuitry 128 on the first substrate 122 of the first chip 120. The second finger 144 may be connected to circuitry 138 on the second substrate 132 of the second chip 130.

A structure herein is especially useful for shielding quantum signals. The amount of energy in a quantum signal is equivalent to a single photon. Even the slightest amount of noise can cause that energy to be lost.

For example, the circuitry 128 on the first chip 120 includes a first qubit 129 at an edge of the first substrate 122, and the circuitry 138 on the second chip 130 includes a second qubit 139 at an edge of the second substrate 132. The circuitry 128 and 138 may each further include superconducting circuits with high quality factor resonators that are slightly non-linear. These superconducting circuits function to map their respective qubits 129 and 139 between a ground state and a first excited state.

The first finger 142 and second finger 144 transmit quantum signals between the first qubit 129 and second qubit 139, and the microwave channel 116 shields the quantum signals from energy loss. Noise is suppressed, and information in the quantum signal is protected.

Moreover, the modes of the microwave cavities 112 and 114 (shown in FIGS. 1-3) can interact with the first qubit 129 and second qubit 139 at the edges of the chips 120 and 130. The first qubit 129 and second qubit 139 might not have shielding. However, the modes are not as strong at the edges. Nevertheless, in addition to shielding quantum signals transmitted by the fingers 142 and 144, the microwave channel 116 (shown in FIGS. 1-3) also shields the first qubit 129 and second qubit 139.

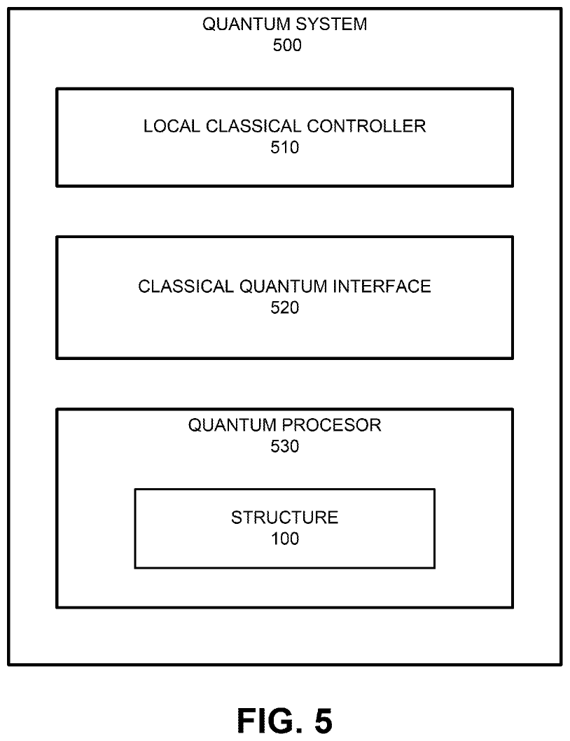

FIG. 5 is an illustration of a quantum system 600 that incorporates a structure herein. The quantum system 500 can be any suitable set of components capable of performing quantum operations on a physical system. In the example embodiment depicted in FIG. 5, the quantum system 500 includes a local classical controller 610, a classical-quantum interface 520, and a quantum processor 530. In some embodiments, all or part of each of the local classical controller 510, the classical-quantum interface 520, and the quantum processor 530 may be located in a cryogenic environment to aid in the performance of the quantum operations.

The quantum processor 530 may be any hardware capable of using quantum states to process information. Such hardware may include a collection of qubits, mechanisms to couple/entangle the qubits, and any required signal routings to communicate between qubits or with classical-quantum interface 520 in order to process information using the quantum states. Such qubits may include, but are not limited to, charge qubits, flux qubits, phase qubits, and spin qubits.

The quantum processor 530 includes a structure 100 that can accommodate at least two chips that carry qubits. Although FIG. 1 shows the structure 100 having only two microwave cavities and a single microwave tunnel, the structure 100 may have more than two chips and corresponding microwave cavities and two or more couplers and corresponding microwave channels. For example, a first microwave channel extends between first and second microwave cavities, a second microwave channel extends between second and third microwave cavities, a third microwave channel extends between third and fourth microwave cavities, and so on.

In some embodiments, there may be one qubit per chip at an edge of the chip, and each chip has an integral finger. Each chip is located in a microwave cavity with its integral finger located in a microwave channel and electrically coupled with the integral finger of an adjacent chip.

In other embodiments, there may be multiple qubits per chip. For example, there may be multiple fingers and corresponding qubits at edges of a chip. Such a chip may connect with qubits on adjacent chips.

The local classical controller 510 may include any combination of classical computing components capable of aiding a quantum computation, such as executing one or more quantum operations to form a quantum circuit, by providing commands to the classical-quantum interface 520 as to the type and order of signals to provide to the quantum processor 530. The local classical controller 510 may additionally perform other low/no latency functions, such as error correction, to enable efficient quantum computations. Such digital computing devices may include processors and memory for storing and executing quantum commands using the classical-quantum interface 520. Additionally, such digital computing devices may include devices having communication protocols for receiving such commands and sending results of the performed quantum computations to a classical backend. Additionally, the digital computing devices may include communications interfaces with the classical-quantum interface 520. In an embodiment, local classical controller 510 may include all components of a computer, or alternatively may include individual components configured for specific quantum computing functionality, such as a processor set, communication fabric, volatile memory, persistent storage, and network module.

The classical-quantum interface 520 may include any combination of devices capable of receiving command signals from the local classical controller 510 and converting those signals into a format for performing quantum operations on the quantum processor 530. Such signals may include electrical (e.g., RF, microwave, DC) or optical signals to perform one or more single qubit operations (e.g., Pauli gate, Hadamard gate, Phase gate, Identity gate), signals to preform multi-qubit operations (e.g., CNOT-gate, CZ-gate, SWAP gate, Toffoli gate), qubit state readout signals, and any other signals that might enable quantum calculations, quantum error correction, and initiate the readout of a state of a qubit. Additionally, the classical-quantum interface 520 may be capable of converting signals received from the quantum processor 530 into digital signals capable of processing and transmitting by the local classical controller 510 and a classical backend. Such signals may include qubit state readouts. Devices included in the classical-quantum interface 520 may include, but are not limited to, digital-to-analog converters, analog-to-digital converters, waveform generators, attenuators, amplifiers, filters, optical fibers, and lasers.

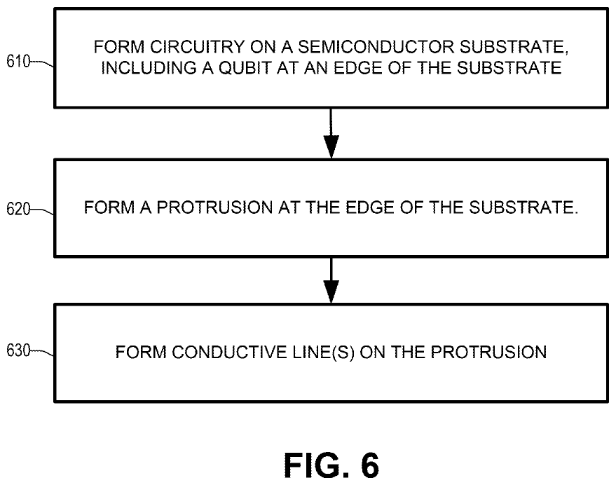

FIG. 6 is a method of fabricating a finger that is integral with a chip, consistent with an illustrative embodiment. At block 610, circuitry is formed on a semiconductor substrate. The circuitry may include a qubit at an edge of the semiconductor substrate.

At block 620, after the circuitry has been formed, a protrusion is formed at the edge of the semiconductor substrate. For example, waterjet-guided laser machining or abrasive waterjet machining may be used to form a millimeter-sized protrusion having an aspect ratio of 2:1 or greater.

At block 630, after the protrusion has been formed, one or more conductive lines are formed on the protrusion. For example, a center trace and two return traces may be deposited to produce a coplanar waveguide. The conductors extend from the circuitry to a free end of the protrusion.

The descriptions of the various embodiments of the present teachings have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

The components, steps, features, objects, benefits and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

Aspects of the present disclosure are described herein with reference to a flowchart illustration and/or block diagram of a method, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

The flowchart and block diagrams in the figures herein illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A structure comprising:
a first chip substantially located in a first microwave cavity, wherein the first microwave cavity has a first mode;
a second chip substantially located in a second microwave cavity, wherein the second microwave cavity has a second mode;
a microwave channel connecting the first microwave cavity and the second microwave cavity, wherein the microwave channel has a third mode, and wherein the third mode dissipates the first mode and the second mode in the microwave channel; and
a coupling from the first chip to the second chip through the microwave channel.

2. The structure of claim 1, wherein the microwave channel has an aspect ratio of greater than 4:1.

3. The structure of claim 1, wherein the coupling comprises:
a first finger extending from the first chip into the microwave channel and terminating in a first end; and
a second finger extending from the second chip into the microwave channel and terminating in a second end that forms a gap with the first end.

4. The structure of claim 3, wherein the first and second fingers include coplanar waveguides.

5. The structure of claim 3, wherein the first and second fingers each have a length-to-width ratio of about 2:1.

6. The structure of claim 3, wherein finger length is at least twice as great as finger width.

7. The structure of claim 3, wherein the first and second ends are electrically coupled across the gap.

8. The structure of claim 3, wherein:
the first chip includes a first semiconductor substrate;
the first finger is integral with the first semiconductor substrate;
the second chip includes a second semiconductor substrate; and
the second finger is integral with the second semiconductor substrate.

9. The structure of claim 3, wherein:
the first chip includes a first qubit;
the second chip includes a second qubit; and
the first and second fingers are configured to transmit quantum signals between the first and second qubits.

10. The structure of claim 9, wherein:
the first qubit is at an edge of the first chip; and
the second qubit is at an edge of the second chip.

11. A quantum system comprising:
a quantum processor comprising;
a conductive body having a plurality of microwave cavities and microwave channels extending between the microwave cavities; and
a plurality of chips located in the microwave cavities,
wherein:
each chip includes at least one qubit and an integral finger protruding from an edge of the chip and extending into an adjacent one of the microwave channels; and
the integral finger of each chip is configured to transmit a quantum signal.

12. The quantum system of claim 11, wherein the at least one qubit of each chip is located at a chip edge.

13. The quantum system of claim 11, wherein:
each chip includes a substrate, and
each finger includes a protrusion integral with the substrate and extending from the substrate.

14. The quantum system of claim 13, wherein the protrusion of each chip is configured as a coplanar waveguide.

15. The quantum system of claim 11, wherein length-to-width ratio of each of the integral fingers of each chip is at least 2:1.

16. The quantum system of claim 11, further comprising:
a local classical controller; and
a classical quantum interface configured to receive command signals from the local classical controller and convert those signals into a format for performing quantum operations on the quantum processor.

17. A method comprising:
forming circuitry on a semiconductor substrate;
machining a millimeter-sized protrusion having an aspect ratio of at least 2:1 at an edge of the semiconductor substrate; and
forming electrical conductors on the protrusion to extend from the circuitry to a free end of the protrusion.

18. The method of claim 17, wherein waterjet-guided laser machining or abrasive waterjet machining are used to machine the protrusion at the edge of the substrate.

19. The method of claim 17, wherein the forming the circuitry includes forming a qubit at the edge of the semiconductor substrate.

20. The method of claim 17, wherein the protrusion and the electrical conductors are configured as a coplanar waveguide.
